(19) United States
(12) Patent Application Publication
(10) Pub. No.: US 2005/0275704 A1
(43) Pub. Date: Dec. 15, 2005

(54) Tool, method for drying recording sheet using the same, method for correcting warpage using the same, and unit having the same

(75) Inventors: Kenichi Yamaguchi, Urayasu-shi (JP); Hitoshi Nagashima, Chigasaki-shi (JP); Makoto Takada, Yokohama-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/145,976

(22) Filed: Jun. 7, 2005

(30) Foreign Application Priority Data
Jun. 9, 2004 (JP) 2004-171238
Jun. 9, 2004 (JP) 2004-171240

(51) Int. Cl. B41J 2/01

(52) U.S. Cl. 347/102

(57) ABSTRACT

Disclosed herein is a tool comprising a pair of holders capable of detachably holding each of both end portions of a recording sheet, and a coupling portion for coupling the pair of holders to each other, wherein the recording sheet forms a curved surface while the recording sheet is held by the pair of holders, and the recording sheet is held by the pair of holders utilizing a restoring force of the recording sheet with the curved surface formed.

### BACKGROUND OF THE INVENTION

1. Field of the Invention

The present invention relates to a tool for holding a recording sheet, and particularly to a tool suitable for use in drying of a recording sheet on which printing has been conducted with an aqueous ink. The present invention also relates to a unit comprising recording sheets and the tool. The present invention further relates to a method for correcting warpage of recording sheets using the tool, and particularly to a method for correcting warpage of ink-jet recording sheets.

2. Related Background Art

In recent years, various recording media have been sold as ink-jet recording media for ink-jet recording. Although ink-jet recording apparatus conduct ink-jet recording on such recording media, recording media suitable for the fixing property of an ink itself used are often limited. Therefore, Japanese Patent Application Laid-Open No. S63-239073 discloses an apparatus that a next recording medium continuously subjected to recording is temporally held in a space above a recording medium previously subjected to recording and is stacked after fixing of an ink on the recording medium previously subjected to the recording is completed. This apparatus is complicated in the construction for satisfying this function and incurs the necessity of enlarging the apparatus.

On the other hand, since postal cards for ink-jet, which come to be used in JAPAN POST, are not optimized for ink properties of the ink-jet recording apparatus, under the circumstances, inks in an undried state on postal cards printed by an ink-jet recording method are dried by arranging the postal cards one by one on a desk or the like in order to dry the inks in the undried state. As a method for simply drying such a postal card, Japanese Patent Application Laid-Open No. 2003-276777 discloses a method in which a sheet member provided with comb-like supporting pieces formed in at least 2 rows by making a great number of cuts in substantially the same direction is used to stand ink-jet recording sheets printed therein, thereby drying them. This method serves to dry a great number of printed products at the same time by hanging them over the 2 comb-like supporting pieces, and it is described that this drying does not require a very wide place.

Further, since an ink-jet recording sheet, particularly, an ink-jet recording sheet classified into coated paper or glossy paper is provided with a coating layer called an ink-receiving layer on at least one surface of a base material thereof, the degree of shrinkage of the paper is different between the front and back thereof, and so such paper has a nature liable to warp on one side. The degree of the warpage of the ink-jet recording sheet varies according to temperature or humidity.

It is also known that an ink-jet recording sheet subjected to ink-jet recording more warps due to expansion or contraction of a recorded surface compared with the sheet before the recording.

Even in the case of single-side printing, a printed product, the printed side of which is concave, cannot but give a feeling of physical disorder because the warpage thereof is opposite to the direction of warpage of silver halide photographs with which users have long communed.

In the ink-jet recording sheets in particular, there is thus a demand for developing a method for solving such problems of warpage as described above.

Japanese Patent Application Laid-Open No. H09-076624 has proposed an ink-jet recording sheet provided with an ink-receiving layer on one surface of a base material thereof and a writing layer on the other surface, in which the writing layer has anticurl property. In Japanese Patent Application Laid-Open No. H10-272828, it has been proposed to prevent curling after ink-jet recording by conducting a treatment of applying an anti-curling liquid after the ink-jet recording. In Japanese Patent Application Laid-Open No. 2003-034072, it has been proposed to prevent warpage by containing an anti-curling agent in base paper of an ink-jet recording sheet.

### SUMMARY OF THE INVENTION

By the way, in the ink-jet recording, apparatus for conducting recording on both surfaces of a recording medium are marketed. However, an ink-jet recording sheet, on both surfaces of which printing has been made, offers a problem on fixing after recording though it varies according to properties of various recording media. An investigation by the present inventors revealed that when a method of conducting printing on one surface, drying the printed surface, turning up the ink-jet recording sheet, conducting printing on the remaining blank surface and then drying it or a method of conducting double-side printing and then leaving the sheet thus printed to stand on the surface of a desk to dry it is performed, a problem that the same print quality cannot be achieved on both surfaces arose though the ink-jet recording sheet used is an ink-jet recording sheet for double-side printing. According to a method of hanging a printed sheet by a washing hanger or the like to dry it, such problems that an image area of the ink-jet recording sheet, particularly, a central area thereof is scratched arose. When printed surfaces of recording sheets subjected to double-side ink-jet recording were put together before they are not sufficiently dried and left to stand, images on both sheets migrated to each other to bring about a white hazy state (hereinafter referred to as “white haze”), thereby deteriorating the image quality. The phenomenon that the images migrate to each other as described above was marked when ink-jet recording media having glossy surfaces and ink-jet recording sheets provided with an ink-receiving layer on a non-absorptive base material, which does not absorb water and the like, such as a PET film or resin-coated paper are stacked on each other. Incidentally, the white haze is considered to be attributable to the fact that a dried portion and an undried portion are produced within the ink-receiving layer, and so the images look turbid by refraction and scattering of light. It is inferred that since a shot-in ink quantity varies according to the place within the recording area, and the dried state of inks varies according to the place when the printed surfaces are put together and left to stand, white haze occurs, which is observed as unevenness of image density, to deteriorate the image quality.

Thus, the present inventors have verified the invention disclosed in Japanese Patent Application Laid-Open No. 2003-276777 to lead to the finding of the following problems. More specifically, ink-jet recording sheets are used in place of the postal cards to conduct ink-jet recording (single-side or double-side recording), and the printed sheets are then placed over both sides of the 2 comb-like supporting pieces (recording-medium-supporting tools). As a result, the dried state of the inks varied between portions coming into contact with the supporting pieces and portions coming into no contact to deteriorate the image quality. In addition, the image areas were damaged because the supporting pieces came into contact with the printed surfaces, and the stiffness (rigidity) of the sheets was lowered by the influence of humidity when used under a high-temperature and high-humidity environment because the recording sheets were left to stand at their own weights, and so the recording media became an unstraightened state to cause problems of, for example, deterioration of quality as recorded articles, such as deformation.

Accordingly, the present invention is to provide an invention, which can solve at least one problem of a first problem that the dried state of the printed recording medium varies between portions coming into contact with the tools and portions coming into no contact to incur the deterioration of the image quality, a second problem that a scratch is caused because the recorded image area of the printed recording medium, particularly, the portion on the central side comes into contact with the tools, a third problem that the stiffness (rigidity) of the paper is lowered by the influence of humidity under a high-temperature and high-humidity environment, and so the printed recording medium cannot be held straightly to cause deterioration of the quality, such as bending of the recorded article, and a forth problem that the image quality of a recording medium subjected to full-surface printing (the so-called borderless printing) is deteriorated at edge portions thereof. The problems described above are problems common to drying of other sheets subjected to recording than the ink-jet recording sheets subjected to single-side or double-side recording.

On the other hand, current ink-jet printers also include those by which a user can select a printing method called “borderless”, in which no blank is left on an ink-jet recording sheet. Since printing is generally conducted while pressing an ink-jet recording sheet at 2 points of “a pinch roller part” and “a spur part” that are printer members, it may scarcely happen that a recording head rubs against the ink-jet recording sheet. However, the ink-jet recording sheet is pressed only by “the pinch roller part” when the above-described “borderless” printing is selected to conduct printing on a leading edge portion of the ink-jet recording sheet. The ink-jet recording sheet is pressed only by “the spur part” when printing is conducted on a trailing edge portion of the ink-jet recording sheet. Therefore, in some cases, the recording head may rub against the ink-jet recording sheet according to the direction of warpage of the ink-jet recording sheet to stain or damage the ink-jet recording sheet. Further, when the recording head impacts the ink-jet recording sheet beyond the degree of the rubbing, the printer itself may be broken down in some cases.

The phenomenon that the recording head rubs against the ink-jet recording sheet easily occurs in the case of a plus-curl state that the recording surface side of the ink-jet recording sheet is concave. Even when the recording surface side of the ink-jet recording sheet is convex, however, the recording head may rub against the ink-jet recording sheet in some cases when the convexity is great. In addition, feeding itself of the ink-jet recording sheet may become infeasible in some cases. Therefore, in order to avoid such a phenomenon as described above, a user has been required to correct warpage to a proper degree of warpage with hands or the like in such a manner that the recording surface side of the ink-jet recording sheet becomes convex so as not to rub against the recording head. When the warpage has been corrected with hands or the like, however, hand grease or the like has attached to a recording surface of the ink-jet recording sheet, and an ink-repelling phenomenon called fingerprint mark may have occurred on a recorded image after ink-jet recording in some cases to markedly deteriorate the image quality.

In recent years, double-side printing has been often conducted, and the same problems as described above have arisen according to conditions when an ink-jet recording sheet has warped at a stage that printing was conducted on one side thereof.

Thus, the present inventors have verified the inventions disclosed in Japanese Patent Application Laid-Open Nos. H09-076624, H10-272828 and 2003-034072 to lead to the finding of the following problems. More specifically, it has been difficult to control the warpage of an ink-jet recording sheet before printing to so proper direction and degree as not to rub against the recording head. It has also been difficult to control the warpage of an ink-jet recording sheet, on one surface of which printing was conducted, to the direction of warpage of silver halide photographs with which users have long communed and a proper degree. Further, it has been difficult to correct the warpage of an ink-jet recording sheet, on one surface of which printing was conducted, and on the other surface of which printing would be conducted next time, to desired direction and degree so as not to rub against the recording head.

Accordingly, the present invention is to provide an invention, which can solve at least one problem of a fifth problem that it is difficult to control the warpage of an ink-jet recording sheet before printing to so proper direction and degree as not to rub against the recording head, a sixth problem that it is difficult to control the warpage of an ink-jet recording sheet, on one surface of which printing was conducted, to the direction of warpage of silver halide photographs with which users have long communed and a proper degree, and a seventh problem that it is difficult to correct the warpage of an ink-jet recording sheet, on one surface of which printing was conducted, and on the other surface of which printing would be conducted next time, to desired direction and degree so as not to rub against the recording head. The problems described above are problems common to problems of warpage of other recording sheets than the ink-jet recording sheets before printing or subjected to printing.

It is thus an object of the present invention to provide a method by which a recording medium subjected to recording can be simply dried without substantially impairing the recorded image condition (preferably, without causing unevenness of drying and any scratch), and a tool suitably used in this method. Another object of the present invention is to provide a unit comprising recording media and a tool suitable for used in drying of the recording medium subjected to recording.

A further object of the present invention is to provide a method for correcting warpage of a recording sheet, by which the warpage can be controlled to proper direction and degree simply and with good results.

In a first aspect of the present invention, there is thus provided a tool to solve the first or second problem among the above-described problems which comprises a pair of holders capable of detachably holding each of both end portions of a recording sheet and a coupling portion for coupling the pair of holders to each other, wherein the recording sheet forms a curved surface while the recording sheet is held by the pair of holders, and the recording sheet is held by the pair of holders utilizing the restoring force of the recording sheet with the curved surface formed.

In a second aspect of the present invention, there is also provided a method for drying a recording sheet to solve the first and second problems among the above-described problems which comprises installing the recording sheet in the pair of holders, with which the tool described above is equipped, to dry the recording sheet.

In a third aspect of the present invention, there is further provided a unit to solve the first, second and third problems among the above-described problems which comprises the tool described above and recording sheets. In this case, it is preferable to contain, in operating instructions or prints, the description that the tool is used in a state that a recording sheet is held by the pair of holders so as to form a curved surface, and moreover to suggest or disclose that the ends of the recording sheet come into point or line contact with the holders.

In a fourth aspect of the present invention, there is still further provided a tool to solve the fourth problem among the above-described problems, wherein the ends of the recording sheet come into point or line contact with the pair of holders while the recording sheet is held by the holders.

In a fifth aspect of the present invention, there is yet still further provided a method for correcting warpage of a recording sheet to solve the fifth problem among the above-described problems which comprises holding the recording sheet by a tool by which each of both end portions of the recording sheet before recording can be detachably held, the recording sheet forms a curved surface while the recording sheet is held, and the recording sheet can be held while utilizing the restoring force of the recording sheet with the curved surface formed.

In a sixth aspect of the present invention, there is yet still further provided a method for correcting warpage of a recording sheet to solve the sixth or seventh problem among the above-described problems which comprises holding the recording sheet by a tool by which each of both end portions of the recording sheet subjected to recording can be detachably held, the recording sheet forms a curved surface while the recording sheet is held, and the recording sheet can be held while utilizing the restoring force of the recording sheet with the curved surface formed.

The first to fourth aspects of the present invention exhibit an effect to solve the first to fourth problems. According to such aspects, there can be provided a method capable of simply drying a recording sheet without causing unevenness of drying and any scratch in a comprehensively necessary image area, and a tool suitably used in this method. There can also be provided a unit comprising recording sheets and a tool suitable for used in drying of the sheet.

The fifth and sixth aspects of the present invention exhibit an effect to solve the fifth to seventh problems. According to such aspects, there can be provided a method for correcting warpage of a recording sheet, by which the warpage can be controlled to proper direction and degree simply and with good results.

### BRIEF DESCRIPTION OF THE DRAWINGS

FIG. 1 is a top view illustrating an exemplary flat tool in the present invention.

FIG. 2 is a perspective view illustrating an exemplary three-dimensional tool in the present invention.

FIG. 3 is a front view of the tool viewed from a direction of A in FIG. 2.

FIG. 4 is a front view of the tool viewed from a direction of B in FIG. 2.

FIG. 5 is an enlarged view in the vicinity of a left end of the tool shown in FIG. 1.

FIG. 6 is an enlarged view in the vicinity of a left end of another exemplary flat tool in the present invention.

FIG. 7 is an enlarged view in the vicinity of a left end of a further exemplary flat tool in the present invention.

FIG. 8 is an enlarged view in the vicinity of a left end of a still further exemplary flat tool in the present invention.

FIG. 9 is a front view illustrating a state that the tool shown in FIG. 2 has been set to a recording sheet.

FIG. 10 is an enlarged view in the vicinity of a left end of a yet still further exemplary flat tool in the present invention.

FIG. 11 is an enlarged view of a contact portion between a projecting piece forming a holder and a recording sheet.

FIG. 12 is a perspective view illustrating a state after the tool shown in FIG. 7 has been three-dimensionally assembled.

FIG. 13 is a front view illustrating an exemplary state that the tool shown in FIG. 7 has been three-dimensionally assembled and set to recording sheets.

FIG. 14 is a front view illustrating another exemplary state that the tool shown in FIG. 8 has been three-dimensionally assembled and set to recording sheets.

FIG. 15 is a front view illustrating a further exemplary state that the tool shown in FIG. 7 has been three-dimensionally assembled and set to recording sheets.

FIG. 16 is a front view illustrating a still further exemplary state that the tool shown in FIG. 8 has been three-dimensionally assembled and set to recording sheets.

FIG. 17 is a perspective view illustrating a state that the tool shown in FIG. 2 has been placed on a desk or the like in a state set to a recording sheet.

FIG. 18 is a top view illustrating an exemplary master sheet having a plurality of tools according to the present invention.

FIG. 19 illustrates an appearance of a printer having holders on a lid at an upper part of the printer.

FIG. 20 illustrates an appearance of a printer having holders on a side surface of the printer.

FIG. 21 is a flow chart illustrating respective steps of preparing a printed product, to one surface of which printing is subjected, applying the method for correcting warpage according to the present invention.

FIG. 22 is a flow chart illustrating respective steps of preparing a printed product, to both surfaces of which printing is subjected, applying the method for correcting warpage according to the present invention.

### DETAILED DESCRIPTION OF THE PREFERRED EMBODIMENTS

The present inventors have investigated, in the course of development of ink-jet recording sheets suitable for use in an ink-jet recording method capable of double-side printing, a drying method thereof and found that ink-jet recording sheets can be simply dried without causing unevenness of drying and any scratch by creating a state that each of the ink-jet recording sheets forms a curved surface and using a tool capable of holding each of both end portions of the ink-jet recording sheet utilizing the restoring force of the recording sheet, thus leading to completion of the invention related to the first to fourth aspects.

The tool according to the present invention comprises a pair of holders capable of detachably holding each of both end portions of a recording sheet, and a coupling portion for coupling the pair of holders to each other, and has the constituted feature that the recording sheet forms a curved surface while the recording sheet is held by the pair of holders, and the recording sheet is held by the pair of holders utilizing the restoring force of the recording sheet with the curved surface formed. The method for drying a recording sheet according to the present invention comprises installing the recording sheet in the pair of holders with which the tool described above is equipped, to dry the recording sheet.

Further, the present inventors have investigated, in the course of development of ink-jet recording sheets suitable for use in an ink-jet recording method capable of double-side printing, the problems (fifth to seventh problems) of warpage of the ink-jet recording sheets and found that the warpage of a warped ink-jet recording sheet can be corrected simply and with good results by holding the ink-jet recording sheet by a tool by which the state that the ink-jet recording sheet forms a curved surface is brought about, and each of both end portions of the ink-jet recording sheet can be held while utilizing the restoring force of the recording sheet with the curved surface formed, thus leading to completion of the invention related to the fifth and sixth aspects.

The method for correcting a recording sheet according to the present invention comprises holding the recording sheet by means of a tool having predetermined functions in a state that the recording sheet forms a curved surface, thereby correcting the recording sheet to a desired state. In the case of an ink-jet recording sheet in particular, the method for correcting warpage of a recording sheet according to the present invention is desirably applied because the ink-jet recording sheet comes to be brought into contact with a recording head.

The method for correcting warpage of a recording sheet according to the present invention may be suitably applied when the necessity for correcting warpage of the recording sheet arises. Preferable application examples will hereinafter be described.

First, before an ink-jet recording sheet is subjected to printing, it is preferable to correct the ink-jet recording sheet in such a manner that a printing surface of the ink-jet recording sheet becomes flat or convex. When the printing surface of the ink-jet recording sheet is flat or convex, the ink-jet recording sheet is prevented from coming into contact with a recording head upon printing. Ink-jet recording sheets are generally sold in a flat state. However, the ink-jet recording sheets may warp in some cases according to selling condition or storing condition after breaking the seal. Accordingly, the method for correcting warpage of a recording sheet according to the present invention is preferably applied according to the state of warpage thereof. The term “flat” as used in the present invention means that the degree of warpage of the recording sheet falls within a range of ±2 mm.

In the case of an ink-jet recording sheet for single-side printing, it is preferable to correct the ink-jet recording sheet in such a manner that a printed surface of the ink-jet recording sheet after printing becomes flat or convex. In generally, a photographed surface of a silver halide photograph or the like often becomes convex because such a state gives a visually more pleasant feeling.

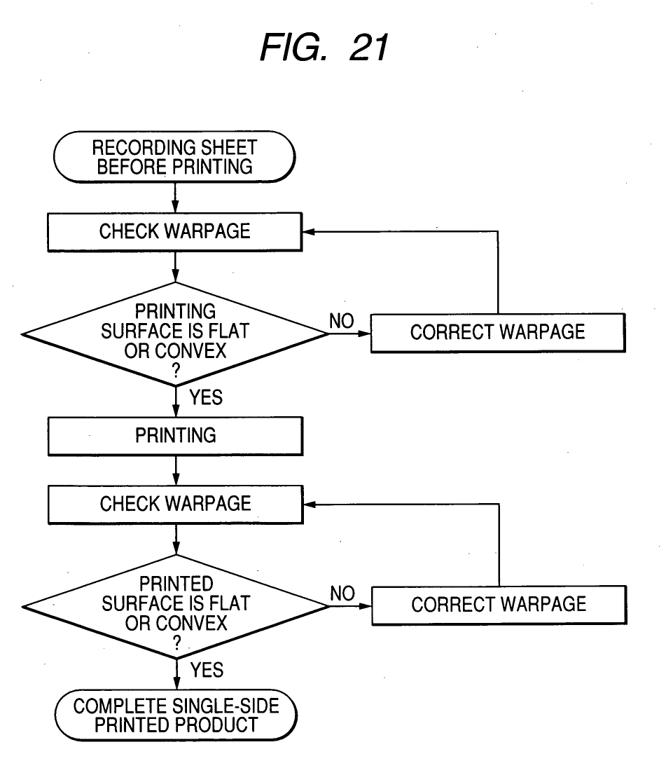

Accordingly, in order to prepare a single-side printed product, the printing is preferably performed in accordance with the flow chart shown in FIG. 21. More specifically, warpage of an ink-jet recording sheet before printing is checked. When a printing surface is neither flat nor convex (is concave), the warpage of the ink-jet recording sheet is corrected by the method according to the present invention until the printing surface becomes flat or convex. After the printing, the warpage of the printed surface is checked. When the printed surface is neither flat nor convex (is concave), the warpage of the ink-jet recording sheet is corrected by the method according to the present invention until the printed surface becomes flat or convex, whereby a single-side printed product is preferably provided.

In the case of an ink-jet recording sheet for double-side printing on the other hand, it is preferable that after printing is conducted on one surface of the ink-jet recording sheet, the ink-jet recording sheet be corrected before subjecting the other surface of the ink-jet recording sheet to printing until the printed surface of the ink-jet recording sheet becomes flat or concave. The ink-jet recording sheet after printing is conducted on one surface thereof may warp in some cases according to the condition of drying. According to the state of the warpage thereof, however, the ink-jet recording sheet may come into contact with a recording head in the same manner as described above when printing is conducted on the other surface thereof. Accordingly, the method for correcting warpage of a recording sheet according to the present invention is preferably applied according to the state of the warpage thereof.

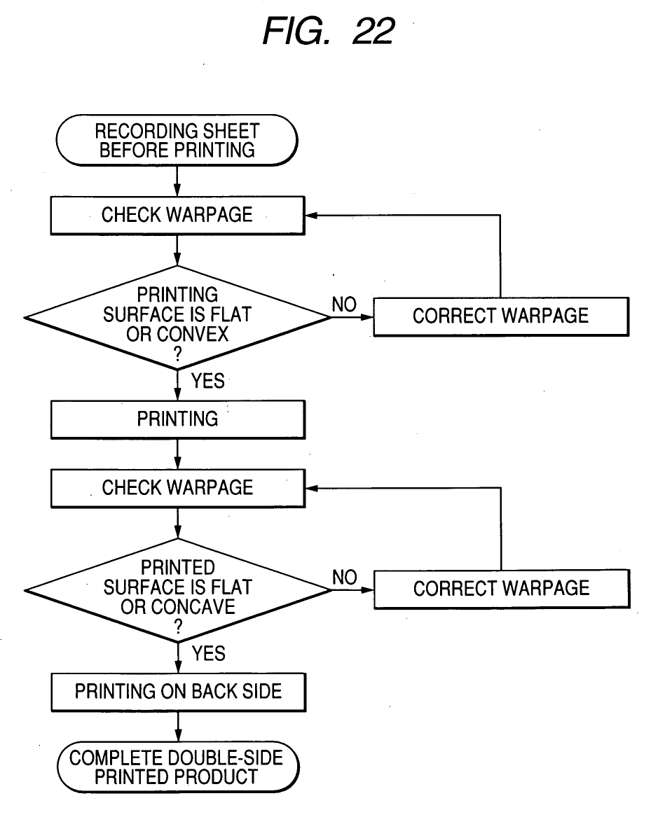

Accordingly, in order to prepare a double-side printed product, the printing is preferably performed in accordance with the flow chart shown in FIG. 22. More specifically, warpage of an ink-jet recording sheet before printing is checked. When a printing surface is neither flat nor convex (is concave), the warpage of the ink-jet recording sheet is corrected by the method according to the present invention until the printing surface becomes flat or convex. After conducting the single-side printing, the warpage of the printed surface is checked. When the printed surface is neither flat nor concave (is convex), the warpage of the ink-jet recording sheet is corrected by the method according to the present invention until the printed surface becomes flat or concave. Thereafter, printing is conducted on the other surface of the ink-jet recording sheet, whereby a double-side printed product is preferably provided.

The holding time may be suitably set in comprehensive consideration of the material of the recording sheet, the degree of warpage before the correction, the material of the tool, the position of the holders, the temperature and humidity of a holding environment, etc. so as to give the recording sheet an intended degree of warpage.

Incidentally, it is generally necessary to dry the ink-jet recording sheet after the printing. The warpage of the ink-jet recording sheet may be corrected as needed after the drying. In the method for correcting the warpage of the recording sheet according to the present invention, however, the recording sheet may also be corrected to desired warpage at the same time as the drying thereof because the recording sheet comes into contact with the tool only at the end portions thereof.

As described above, the tool having predetermined functions is used in the present invention. The construction of tools usable at the time the present invention is executed will be described.

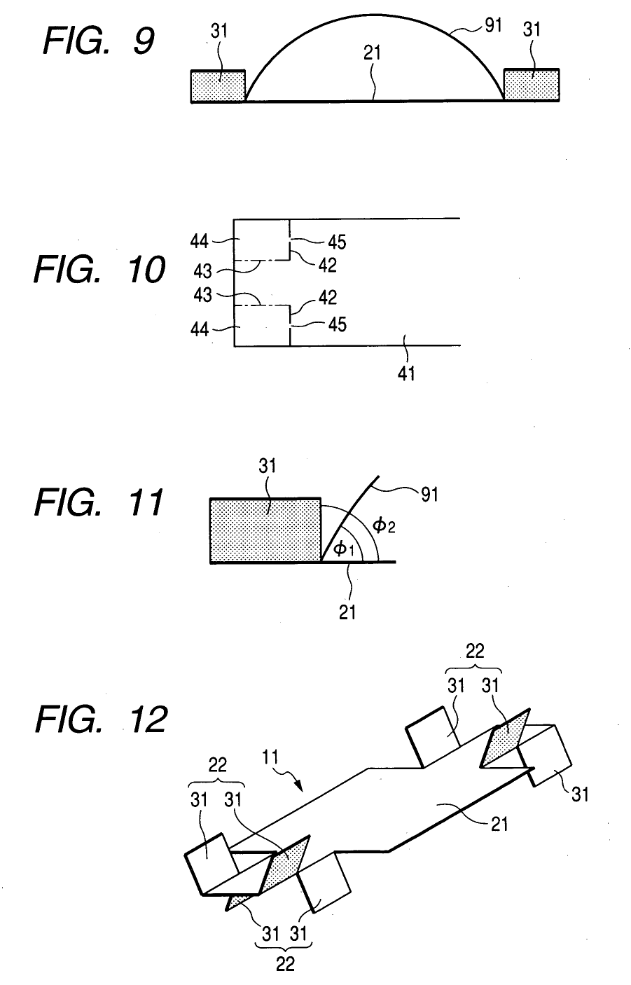

FIG. 2 is a perspective view illustrating an example of the specific construction of a tool according to the present invention, and FIGS. 3 and 4 are front views of the tool viewed from respective directions of A and B in FIG. 2. This jug 11 is constructed by a pair of holders 22 each composed of projecting pieces 31 and a coupling portion 21 for coupling the holders to each other. A state that a recording sheet 91 has been set in this tool 11 is illustrated in FIG. 9 as a front view when the tool 11 has been viewed from the direction of B in FIG. 2. As illustrated in FIG. 9, each of both end portions of the recording sheet 91 is held by the projecting pieces 31 forming the pair of holders. At this time, the recording sheet 91 is in a state that it has formed a curved surface. Although the recording sheet 91 attempts to return to a flat surface, the projecting pieces 31 forming the holders exhibit a function of a stopper, so that the recording sheet 91 is held by self-restoring force while the state of the curved surface is retained.

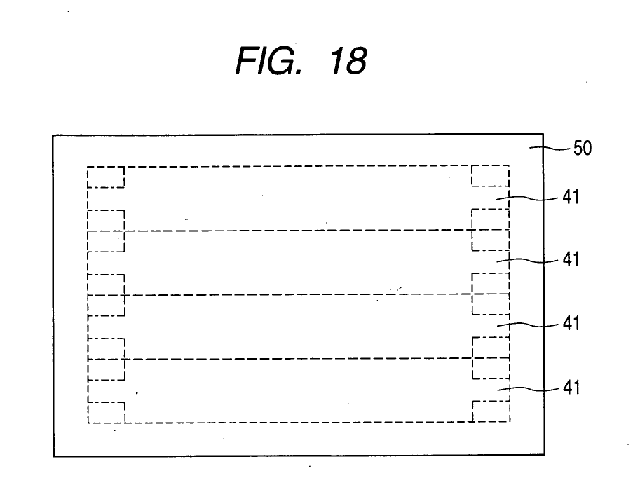

FIG. 17 is a perspective view illustrating a state that the tool 11 has been placed on a desk or the like in a state set to the recording sheet 91. Since the recording sheet 91 is held in the state that the curved surface has been formed, it can be easily stood. At this time, the tool 11 is supported by the restoring force of the recording sheet 91, and so it is prevented from spontaneously falling off. When the recording sheet 91 is intended to release, it is further slightly curved, whereby the recording sheet 91 can be easily released from the tool 11 without a scratch.

As described above, the tool having the constitution of the present invention can bring about a state that the recording sheet has been brought into contact only at the end portions thereof. In other words, the recording sheet can be dried simply and evenly by conducting drying in a state that the recording sheet has been installed in the pair of holders with which the tool is equipped. As a condition during the drying, the recording sheet may be stood on the desk or the like as illustrated in FIG. 17 or placed on the desk or the like with the tool down, or the tool may be hanged by a washing hanger or the like.

Here, an enlarged view of a contact portion between the projecting piece 31 forming the holder and the recording sheet 91 in a state that the tool 11 has been set to the recording sheet 91 is illustrated in FIG. 11. At this time, it is preferable that an angle Φ₁ formed between the recording sheet 91 and the coupling portion 21 be narrower than an angle Φ₂ formed between the projecting piece 31 forming the holder and the coupling portion 21, and an end of the recording sheet and the holder be in a state coming into point or line contact with each other. In this state, a printing surface of the recording sheet comes into no contact with the holder, so that the recording sheet can be suitably dried even when it is subjected to borderless printing. The angle Φ₂ is preferably at most 90° C. from the viewpoint of realizing good holding power.

The tool according to the present invention can be used for drying various kinds of recording sheets such as ink-jet recording sheets and recording sheets for photographs. In particular, it can be preferably used in drying of ink-jet recording sheets that have had many problems in drying method, and can be particularly preferably used in drying of ink-jet recording sheets capable of double-side printing.

The tool used in the present invention can be used for correcting warpage of various kinds of recording sheets such as ink-jet recording sheets and recording sheets for photographs. In particular, it can be preferably used in drying of ink-jet recording sheets, in which problems of warpage easily arise, and can be particularly preferably used in correction of warpage of ink-jet recording sheets capable of double-side printing.

No particular limitation is imposed on the ink-jet recording sheets, and the present invention may be applied to recording sheets of any sizes such as A series sizes, B series sizes, letter size, postal card size, and L size, 2L size, 4×6 cm size, 8×10 inch size and 10×12 inch size, to which silver halide photographs are accustomed. It is only necessary to adjust the size and form of the tool to the size of the recording sheet. More specifically, the length of a long side of the recording sheet must be shorter than a length between the holders of the tool. Assuming that the length of the long side of the recording sheet is B, and the length between the holders of the tool is L (see FIG. 2), it is preferable to satisfy 2B/3≦L≦9B/10.

No particular limitation is also imposed on the kind of the material of the ink-jet recording sheet. However, the present invention is preferably applied to ink-jet recording sheets using resin-coated paper as a base material in view of the intensity of the restoring force of the ink-jet recording sheet, less curling after drying, etc.

In order to develop the restoring force while the recording sheet is held in the curved form, the recording sheet preferably has some rigidity (stiffness). The rigidity is preferably 300 to 5,000 mgf, more preferably 300 to 4,000 mgf in accordance with the measuring method prescribed in J. TAPPI No. 40. In the case of an ink-jet recording sheet, the rigidity is particularly preferably 500 to 3,000 mgf from the viewpoints of conveying ability in an ink-jet printer, the intensity of the restoring force, etc. A proper thickness is also important for realizing high restoring force. In the case of, for example, an ink-jet recording sheet, the thickness is preferably 100 to 500 μm. The thickness is more preferably 180 to 350 μm in view of conveying ability in an ink-jet printer, the intensity of the restoring force, less curling after drying, etc. The thickness is particularly preferably 200 to 300 μm.

As a material of the tool, may be used paper such as art paper, glossy paper, bond paper, regenerated paper, baryta paper, cast-coated paper, coated board, corrugated fiberboard, paperboard, tree free paper or synthetic paper; a resin such as polyethylene terephthalate, diacetate, triacetate, celluloid, polycarbonate, polyimide, polyacrylate, polyethylene, polypropylene or ABS; wood such as ply wood, the Japanese cypress or cedar; a metal such as aluminum, iron, copper, brass or stainless steel; or a rubbery elastic substance.

Either a tool composed of an absorptive member easy to absorb water or a tool composed of a non-absorptive member hard to absorb water may also be used. However, the tool composed of the absorptive member very hard to cause unevenness of drying at end portions of the recording sheet is preferably used. Even in the non-absorptive member, however, it is likewise very hard to cause the unevenness of drying at end portions of the recording sheet when the surface thereof is subjected to a hydrophilizing treatment.

The surface of the tool may be smooth or irregular, and the tool may be transparent, translucent or opaque. The tool may also be made from a material obtained by laminating two or more such materials on each other. Further, various kinds of decorations and colorings may be applied as a part of interior.

Since there is a need of holding the recording sheet in the curved form, the tool is preferably produced with cardboard such as coated board or paperboard in view of strength and cost when the material of the tool is paper. The thickness thereof is preferably 0.2 to 2 mm, more preferably 0.3 to 1 mm from the viewpoints of the strength of the tool, easy processing and cost. Since other materials are high in strength compared with paper, no particular limitation is imposed on the thickness thereof so far as it can hold the recording sheet in the curved form. When it is used as, for example, a part of interior, it is preferable that the thickness be great, and decoration be made in its own way.

When the tool is made from a material incapable of being easily bent, it is only necessary to make a tool having the predetermined shape capable of developing the function of the present invention by a method such as in-mold one-piece molding or melt molding. The shape of the tool at this time may be optionally set so as to permit developing the function of the invention of the present application. In other words, the shape of the coupling portion is limited to such a flat form as illustrated in FIG. 2, but may be, for example, columnar or cylindrical. The shape of the holder is not limited to such a form obtained by bending a flat sheet as illustrated in FIG. 2, but may be, for example, columnar, cylindrical or spherical. Further, it may be of a form of a character in view of interior property.

In the case of a tool made from a material capable of being easily bent, such as paper, or a plastic such as polystyrene or ABS, a tool having a predetermined shape from the beginning as described above may be provided. However, for example, the tool may be so constructed that a flat tool is provided so as to three-dimensionally assemble it later on.

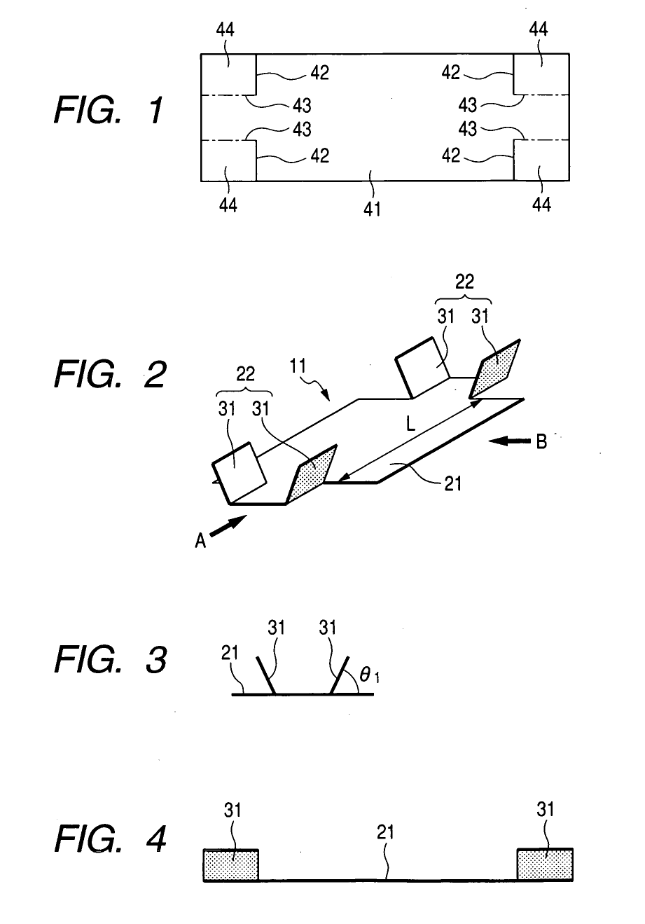

FIG. 1 is a top view illustrating an exemplary flat tool capable of forming the tool shown in FIG. 2. The tool shown in FIG. 1 is composed of a planar member 41 and has bending portions divided by a cut 42 and a fold 43 at 4 corners thereof. The bending portions 44 can be three-dimensionally bent along the respective folds 43, thereby forming projecting pieces. Such a tool may be made with cardboard such as coated board or paperboard, thereby easily provide a three-dimensional tool. A bending angle θ₁ shown in FIG. 3 may be optionally selected within a range of 0°<θ₁<180° so far as the function of the invention of the present application can be exhibited. However, the angle is preferably within a range of 30°<θ₁<120° in consideration of practical points of view, such as the restoring force of the recording medium and easy reuse. Incidentally, in the embodiment illustrated in FIG. 2, one holder is formed by 2 projecting pieces. However, even one projecting piece can exhibit the function of the invention of the present application. More specifically, 2 bending portions of the tool shown in FIG. 1 are bent in opposite directions to each other, thereby providing a tool capable of holding 2 recording sheets on front and back surfaces thereof.

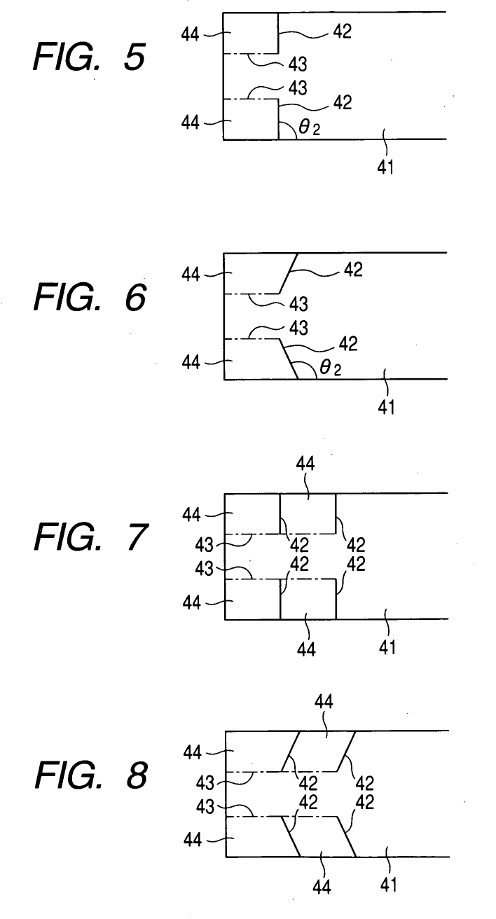

FIG. 5 is an enlarged view in the vicinity of a left end of the flat tool shown in FIG. 1. In this embodiment, a cut 42 is made perpendicularly (in FIG. 5, θ₂=90°) to an edge of the planar member. However, this angle may be optionally selected within a range capable of developing the function of the invention of the present application. For example, the cut 42 may also be made so as to slant (in FIG. 6, θ₂>90°) from the edge of the planar member as illustrated in FIG. 6. The cut slantingly made can more improve the ability to hold the ink-jet recording sheet. The angle thereof is preferably 90°>θ₂>150° in consideration of the practical points of view. The position and length of the cut may also be optionally set within a range capable of developing the function of the invention of the present application. The angles, positions and lengths of the respective cuts may be the same or different from one another.

It is preferable to provide an uncut portion 45 in the middle of the cut 42 as illustrated in FIG. 10. The provision of the uncut portion 45 permits lessening the bending of the bending portion 44 before use. The uncut portion 45 may be provided at one place or two or more places of one cut.

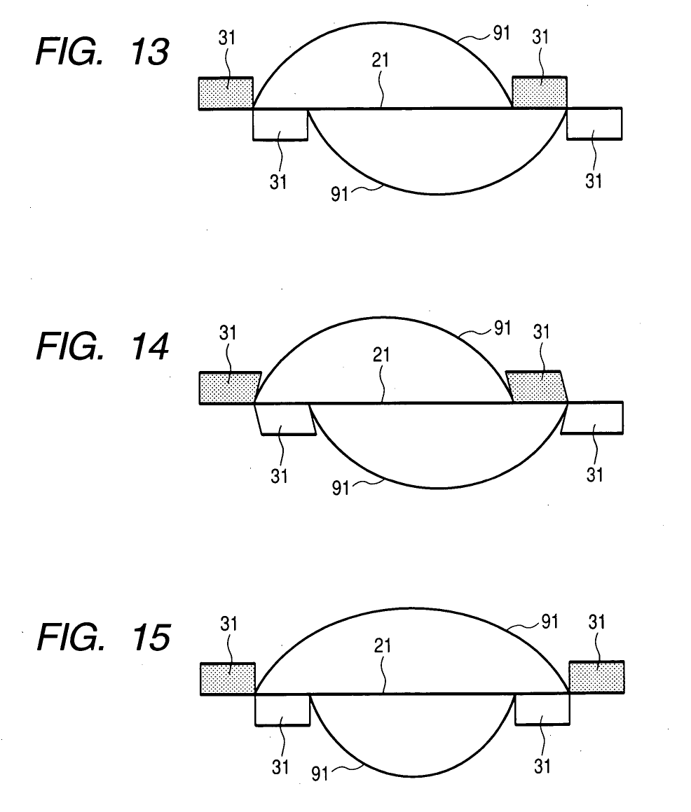

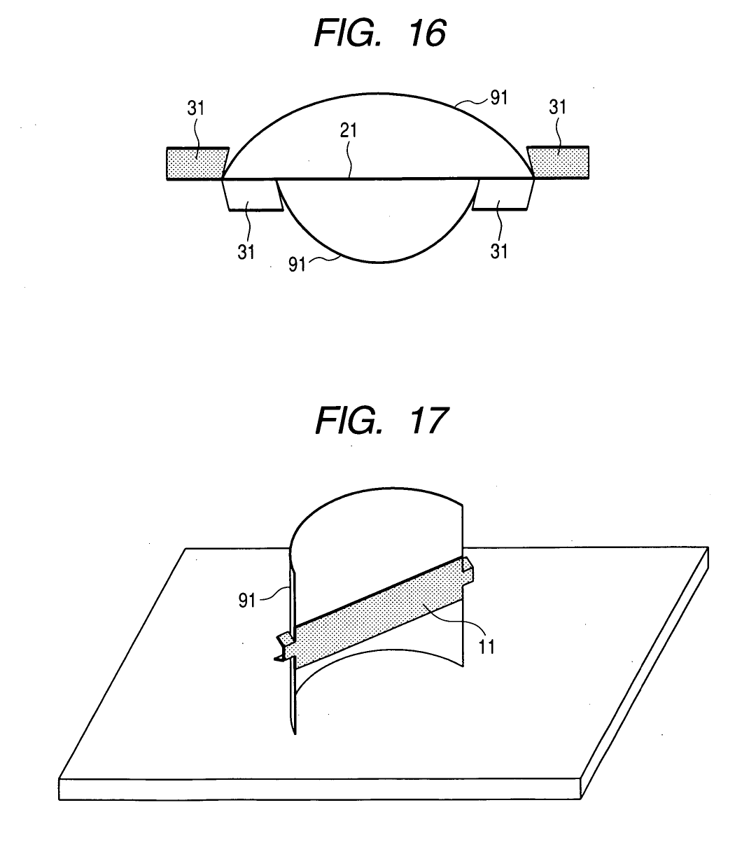

Two cuts 42 may be made from the same edge at each of 4 corners of the planar member 41 to provide 2 bending portions 44 at each corner. In this case, the two bending portions may be bend in opposite directions to each other, thereby providing such a three-dimensional form as illustrated in, for example, FIG. 12. This tool 11 can hold 2 recording sheets at the same time (FIG. 13: a front view illustrating a state that the recording sheets have been set therein), thereby improving the drying efficiency. In the case of this tool, changing the bending directions permits coping with holding 2 recording sheets different in size at the same time (FIG. 15: a front view illustrating a state that the recording sheets have been set therein). The tool may also be provided in a state that the cuts 42 have been slantingly made (FIG. 8: a top view; FIGS. 14 and 16: front views illustrating a state that recording sheets have been set therein).

Although the tool that a tool in a flat state is assembled in a three-dimensional state as described above is used in the three-dimensional state, it is convenient that it can be restored to the flat state. The tool that can be reversibly changed between the three-dimensional state and the flat state can be easily stored into a package of recording sheets.

A master sheet 50, of which some planar members 41 can be cut out as illustrated in FIG. 18, may be provided. In this case, peripheries of the tools are preferably worked with cut portions and uncut portions in such a manner that the planar members 41 can be easily cut off one by one. In FIG. 18, the constitution that 4 planar members 41 are arranged is illustrated as an example. However, the number of the planar members arranged may be suitably controlled according to strength, the thickness and rigidity of a recording sheet to be held, and the like. The angle, position, length and the like of each cut may also be suitably set.

Since such tools as described above may be suitably used in drying of recording sheets and correction of warpage of recording sheets, a unit comprising recording sheets and such a tool is preferably provided. In particular, the tool that a part of the planar member is three-dimensionally bent to form projecting pieces can be easily put into a package of recording sheets, and so it is preferred upon the provision of the unit. At this time, the length of a long side of the planar member, which will become a tool, is preferably adjusted to a length not longer than the length of a long side of an ink-jet recording sheet. By adjusting to such a length, the tool can be easily put into the package of the recording sheets without enlarging the size of the whole unit. In this case, it is preferable to contain, in operating instructions or prints, the description that the tool is used in a state that a recording sheet is held by a pair of holders so as to form a curved surface, and moreover to suggest or disclose that the ends of the recording sheet come into point or line contact with the holders.

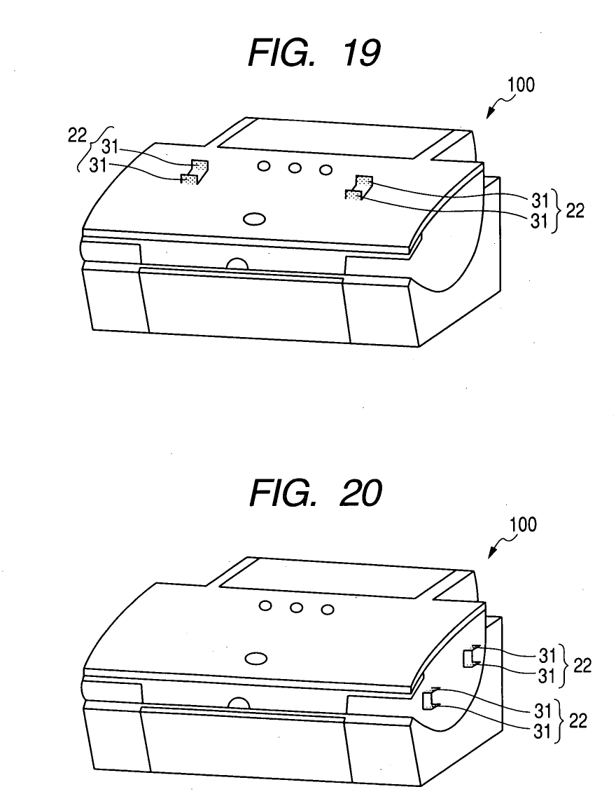

As another embodiment, the projecting pieces, which will become the holders, may be formed directly on a printer. Positions at which the projecting pieces to become the holders are formed may be on either a lid (FIG. 19) at an upper part of the printer or a side surface (FIG. 20) thereof. It is preferable that the projecting pieces be foldably formed because they are folded after use. The holder may be of a form of a character in view of interior property. Alternatively, it is preferable that a tool punched be detachably arranged on the surface of the printer using a magnet or the like.

The present invention will hereinafter be described in more detail by the following examples related to the first to fourth aspects.

Production of Tools 1 to 8

A coated board (thickness: about 380 μm) of 4 cm in short side and 28 cm in long side was used to produce such flat tools as described below.

(Tool 1)

A tool having cuts shown in FIG. 5 was provided. The cuts were made at a position 15 mm distant from a left end in length of 12 mm, and the angle θ₂ of each cut was set to 90°.

(Tool 2)

A tool having cuts shown in FIG. 6 was provided. The cuts were made from a position 15 mm distant from a left end in length of 12 mm, and the angle θ₂ of each cut was set to 92°.

(Tool 3)

A tool having cuts shown in FIG. 7 was provided. The cuts were made at positions 15 mm and 30 mm distant from a left end in length of 12 mm, and the angle θ₂ of each cut was set to 90°.

(Tool 4) A tool having cuts shown in FIG. 8 was provided. The cuts were made from positions 15 mm and 30 mm distant from a left end in length of 12 mm, and the angle θ₂ of each cut was set to 92°.

(Tool 5)

A tool having cuts shown in FIG. 6 was provided. The cuts were made from a position 15 mm distant from a left end in length of 12 mm, and the angle θ₂ of each cut was set to 100°.

(Tool 6)

A tool having cuts shown in FIG. 6 was provided. The cuts were made from a position 40 mm distant from a left end in length of 12 mm, and the angle θ₂ of each cut was set to 120°.

(Tool 7)

A tool having cuts shown in FIG. 5 was provided. The cuts were made at a position 70 mm distant from a left end in length of 12 mm, and the angle θ₂ of each cut was set to 90°.

(Tool 8)

A tool having cuts shown in FIG. 5 was provided. The cuts were made at a position 5 mm distant from a left end in length of 12 mm, and the angle θ₂ of each cut was set to 90°.

(Printing on Ink-Jet Recording Sheet)

Black-color printing was conducted on the whole area of both surfaces of A4-sized double-side glossy paper (product of Konica Photo Imaging Corporation, trade name: Photolike QP Ryomen Kotaku Atsude) by means of an ink-jet printer (manufactured by Canon Inc., trade name: PIXUS 950i).

Conditions for Printing

Paper setting: ProPhoto Paper

Presence of margin: borderless

Application: PhotoShop (trademark) 7.0

Designation of black: black 100%.

### EXAMPLE 1

Tool 1 was three-dimensionally assembled as shown in FIG. 2 (bending portions 44 were bent by 60° to form projecting portions 31), and the ink-jet recording sheet subjected to the printing was set in the tool, stood on a desk as shown in FIG. 17 and left to stand for 16 hours. The ink-jet recording sheet was then taken out of the tool to make evaluation as to the following items. The evaluation results are shown in Table 1.

Evaluation Items

Item 1: Evenness of Image Quality (Between an End Portion and Any Other Portion)

∘: No difference is observed;
Δ: Some difference was observed; and
x: A clear difference from other portions was observed, and a mark due to unevenness of density was left.
   Item 2: Image Quality (Difference in Density/Tint Between Front and Back Surfaces)
∘: No difference in density/tint is observed between front and back surfaces;
Δ: A difference in density/tint is observed only between end portions of front and back surfaces; and
x: A difference in density/tint is wholly observed between front and back surfaces.
   Item 3: Presence of Scratch:
∘: No scratch is observed;
Δ: A small scratch was observed; and
x: A large scratch was observed.
   Item 4: Behavior upon Self Test under Environment of 30° C./80% RH

A test of leaving a sample to stand for 24 hours under environment of 30° C./80% RH was separately conducted to observe the behavior of the sample upon the shelf test.
∘: No change was observed; and
x: The sample differed from that before 24 hours.
   Item 5: Holdability of Recording Sheet
∘: Stably held by the tool; and
x: There was need of separately supporting the tool upon holding.

### EXAMPLE 2

An experiment was carried out in the same manner as in EXAMPLE 1 except that Tool 2 was used. The evaluation results are shown in Table 1.

### EXAMPLES 3 and 4

Experiments in EXAMPLES 3 and 4 were carried out in the same manner as in EXAMPLE 1 except that Tools 3 and 4 were respectively used, and the ink-jet recording sheets subjected to the printing were set in both sides of the respective tools. The evaluation results are shown in Table 1.

### EXAMPLES 5 and 6

Experiments in EXAMPLES 5 and 6 were carried out in the same manner as in EXAMPLE 1 except that Tools 5 and 6 were respectively used. Incidentally, Tool 6 came into contact with the surface at end portions of the ink-jet recording sheet. The evaluation results are shown in Table 1.

### COMPARATIVE EXAMPLE 1

No tool was used to flatly place the ink-jet recording sheet subjected to the printing on a desk and leave it to stand for 16 hours. Thereafter, evaluation was made in the same manner as in EXAMPLE 1. The evaluation results are shown in Table 1.

### COMPARATIVE EXAMPLE 2

Such a sheet member provided with comb-like supporting pieces formed in at least 2 rows by making a great number of cuts in substantially the same direction as disclosed in Japanese Patent Application Laid-Open No. 2003-276777 was produced, and 4 ink-jet recording sheets subjected to the printing were stood therein and left to stand for 16 hours. Thereafter, evaluation was made in the same manner as in EXAMPLE 1. The evaluation results are shown in Table 1.

### COMPARATIVE EXAMPLE 3

An experiment was carried out in the same manner as in EXAMPLE 1 except that Tool 7 was used. Incidentally, folds occurred at a part of the ink-jet recording sheet upon setting of the ink-jet recording sheet. However, the sheet was left to stand for a predetermined period of time as it is. Thereafter, evaluation was made in the same manner as in EXAMPLE 1. The evaluation results are shown in Table 1.

### COMPARATIVE EXAMPLE 4

An experiment was carried out in the same manner as in EXAMPLE 1 except that Tool 8 was used. Incidentally, since the ink-jet recording sheet was not stably held, the sheet was left to stand for 16 hours while separately supporting the tool. Thereafter, evaluation was made in the same manner as in EXAMPLE 1. The evaluation results are shown in Table 1.

TABLE 1

| | Item 1 | | | | | |
|---|---|---|---|---|---|---|
| | End | Other | | | | |
| | portion | portion | Item 2 | Item 3 | Item 4 | Item 5 |
| EX. 1 | ∘ | ∘ | ∘ | ∘ | ∘ | ∘ |
| EX. 2 | ∘ | ∘ | ∘ | ∘ | ∘ | ∘ |
| EX. 3 | ∘ | ∘ | ∘ | ∘ | ∘ | ∘ |
| | ∘ | ∘ | ∘ | ∘ | ∘ | ∘ |
| EX. 4 | ∘ | ∘ | ∘ | ∘ | ∘ | ∘ |
| | ∘ | ∘ | ∘ | ∘ | ∘ | ∘ |
| EX. 5 | ∘ | ∘ | ∘ | ∘ | ∘ | ∘ |
| EX. 6 | Δ | ∘ | Δ | ∘ | ∘ | ∘ |
| COMP. | x | x | x | Δ | ∘ | — |
| EX. 1 | | | | | | |
| COMP. | ∘ | x | ∘ | x | x | ∘ |
| EX. 2 | | | | | | |
| COMP. | x | x | Δ | x | ∘ | ∘ |
| EX. 3 | | | | | | |
| COMP. | ∘ | ∘ | ∘ | ∘ | ∘ | x |
| EX. 4 | | | | | | |

As described above, it was known that the recording sheets can be simply dried according to the present invention without causing unevenness of drying and any scratch.

The present invention will hereinafter be described in more detail by the following examples related to the fifth and sixth aspects.

Preparation of Ink-Jet Recording Sheet 1

<Preparation of Base Material>

After 90 parts by mass of LBKP (Laulholz (deciduous) bleached kraft pulp) having a freeness of 450 ml CSF (Canadian Standard Freeness) and 10 parts by mass of NBKP (Nadelholz (coniferous) bleached kraft pulp) having a freeness of 450 ml CSF were mixed as raw pulp and beaten, 10 parts by mass of kaolin (product of Tsuchiya Kaolin Ind., Ltd.), 0.1 parts by mass of alkenylsuccinic anhydride and 0.2 parts by mass of cationized starch (product of NIPPON STARCH CHEMICAL CO., LTD., trade name: Petrosize J) were blended to make a paper substrate having a basis weight of 150 g/m² and a Stöckigt sizing degree of 10 seconds in accordance with a method known per se in the art.

<Preparation of Under Coat>

To 100 parts by mass of high-purity alumina (product of Sumitomo Chemical Co., Ltd., trade name: AKP-G015, flake alumina, bulk density: 0.07 g/cm³, specific surface area: 150 m²/g) as a pigment were added 20 parts by mass of polyvinyl alcohol (trade name: PVA 117, product of Kuraray Co., Ltd.) as an adhesive and 0.5 parts by mass of sodium polyphosphate as a dispersant, and they were mixed to prepare a coating formulation for primer coating having a solid concentration of 15% by mass.

This coating formulation for primer coating was applied to the base material prepared above by a bar coater so as to give a dry coating mass of 15 g/m², and then dried to obtain primed base paper.

<Preparation of Glossy Layer>

A cast coating formulation having a solid concentration of 30% by mass was prepared from 40 parts by mass of a styrene-2-methylhexyl acrylate copolymer having a glass transition temperature of 80° C., 60 parts by mass of colloidal silica (product of Nissan Chemical Industries, Ltd., trade name: SNOWTEX 20) and 2 parts by mass of calcium stearate as a parting agent.

After this coating formulation was applied to the primed base paper by means of a bar coater, the base paper was immediately brought into contact under pressure with a mirror-finished drum having a surface temperature of 85° C. to dry it. The base paper thus treated was then separated from the drum to obtain an A4-sized Ink-Jet Recording Sheet 1, the printed side of which was concave. The coating weight at this time was 5 g/m² in terms of a solid mass.

Preparation of Ink-Jet Recording Sheet 2

<Preparation of Base Material>

After wood pulp composed of 70 parts by mass of LBKP having a freeness of 450 ml CSF and 30 parts by mass of NBKP having a freeness of 450 ml CSF was mixed with 5 parts by mass of a pigment comprising precipitated calcium carbonate/heavy calcium carbonate/talc at a mass ratio of 30/35/35, 0.1 parts by mass of a commercially-available alkylketene dimer (product of Arakawa Chemical Industries, Ltd., trade name: Sizepine NT-76), 0.03 parts by mass of a commercially-available cationic acrylamide (product of Arakawa Chemical Industries, Ltd., trade name: Arafix 100), 1.0 part by mass of a commercially-available cationized starch (product of NIPPON STARCH CHEMICAL CO., LTD., trade name: Petrosize J) and 0.5 parts by mass of aluminum sulfate (product of Taki Chemical Co., Ltd., trade name: Ryusan Aluminum), paper was made at a basis weight of 100 g/m² by means of a publicly known Fourdrinear paper machine and dried to obtain an air-permeable base material.

<Preparation of Ink-Receiving Layer>

A coating formulation for an ink-receiving layer was prepared by using 100 parts by mass of synthetic amorphous silica (trade name: Finesil X37B, product of Tokuyama Corp.) and 30 parts by mass of polyvinyl alcohol (trade name: PVA 117, product of Kuraray Co., Ltd.) and adjusting a solid concentration to 13% by mass. This coating formulation was then applied to the base material prepared above by a bar coater so as to give a dry coating weight of 30 g/m². The coating formulation was further applied likewise to the other surface so as to give a dry coating weight of 30 g/m² to form ink-receiving layers. The base material thus coated was subjected to supercalendering to prepare an A4-sized flat Ink-Jet Recording Sheet 2 (double-side mat paper) free of warpage (the degree of warpage: within a range of ±1 mm).

Conditions for Ink-Jet Recording

<Ink-Jet Printer>

Manufactured by Canon Inc., PIXUS 950i (trade name).

<Setting of Driver in Printing on Ink-Jet Recording Sheet 1>

Paper setting: ProPhoto Paper (top grade)
Presence of margin: borderless.
   <Setting of Driver in Printing on Ink-Jet Recording Sheet 2>
Paper setting: high-quality dedicated paper (top grade)

Presence of margin: borderless.

| | |
|---|---|
| <Image recorded> | |
| Ink-Jet Recording Sheet 1: | black 100% on the |
| | whole area of A4-size |
| Ink-Jet Recording Sheet 2: | black 100% on the |
| | whole area of A4-size |
| | (first printing |
| | surface, |
| | black 40% on the whole |
| | area of A4-size |
| | (second printing |
| | surface. |
| <Application> | |
| PhotoShop (trademark) 7.0. | |

### EXAMPLE 7

Ink-Jet Recording Sheet 1 was set in the tool shown in FIG. 2 in such a manner that the glossy surface thereof turned to the outside, and left to stand for 16 hours. Thereafter, Ink-Jet Recording Sheet 1 was taken out of the tool. The degrees of warpage of Ink-Jet Recording Sheet 1 before and after left to stand were determined. The results are shown in Table 2.

Printing was then conducted on Ink-Jet Recording Sheet 1. Whether the ink-jet recording sheet rubbed against an ink-jet head at that time or not was confirmed. The result is shown in Table 2.

Details of Tool Shown in FIG. 2:

A coated board (thickness: about 380 μm) of 4 cm in short side and 28 cm in long side was used to produce a tool having cuts shown in FIG. 5. The cuts were made at a position 15 mm distant from a left end in length of 12 mm, and the angle θ₂ of each cut was set to 90°.

### EXAMPLE 8

Since the printed surface of the printed product obtained in EXAMPLE 1 became concave, the printed product was set again in the tool shown in FIG. 2 in such a manner that the printed surface turned to the outside, and left to stand for 4 hours. The degrees of warpage of the ink-jet recording sheet before and after left to stand were determined. The results are shown in Table 2.

### EXAMPLE 9

Since Ink-Jet Recording Sheet 2 was flat (the degree of warpage: within a range of ±1 mm), the sheet was not corrected to first conduct printing on one surface (first printing surface) thereof. Rubbing between the ink-jet recording sheet and the ink-jet head did not occur upon this printing.

Since the condition after the printing was confirmed, and the first printing surface was found to become convex, the ink-jet recording sheet was set in the tool in such a manner that the second printing surface, which was a back surface of the sheet, turned to the outside, and left to stand for 1 hour. The degrees of warpage of Ink-Jet Recording Sheet 2 before and after left to stand were determined. The results are shown in Table 2.

Printing was then conducted on the second printing surface. Whether the ink-jet recording sheet rubbed against an ink-jet head at that time or not was confirmed. The result is shown in Table 2.

### COMPARATIVE EXAMPLE 5

The degree of warpage of Ink-Jet Recording Sheet 1 was determined, and printing was then conducted as it is. Whether the ink-jet recording sheet rubbed against an ink-jet head at that time or not was confirmed. The results are shown in Table 2.

### COMPARATIVE EXAMPLE 6

Printing was conducted on one surface (first printing surface) of Ink-Jet Recording Sheet 2. After the printing, the degree of warpage of Ink-Jet Recording Sheet 2 was determined, and printing was then conducted on the second printing surface, which was a back surface of the sheet, as it is. Whether the ink-jet recording sheet rubbed against an ink-jet head at that time or not was confirmed. The results are shown in Table 2.

### COMPARATIVE EXAMPLE 7

Since Ink-Jet Recording Sheet 2 was flat (the degree of warpage: within a range of ±1 mm), the sheet was not corrected to first conduct printing on one surface (first printing surface) thereof. The condition after the printing was confirmed, and the degree of warpage of the ink-jet recording sheet was determined. Since the first printing surface became convex, the warpage was corrected by rounding the sheet with the second printing surface turned to the outside. However, fine adjustment could not be made, and so the sheet greatly warped in the reverse direction (the first printing side became concave). In addition, a part of Ink-Jet Recording Sheet 2 bent. Thereafter, printing was conducted as it is. Whether the ink-jet recording sheet rubbed against an ink-jet head at that time or not was confirmed. The results are shown in Table 2.

TABLE 2

Degree of warpage (mm)

| | Before | After | Rubbing |
|---|---|---|---|
| | correction | correction | against head |
| EX. 7 | +8 | −1 | ∘ |
| EX. 8 | +5 | −3 | — |
| EX. 9 | −9 | +3 | ∘ |
| COMP. | +7 | — | x |
| EX. 5 | | | |
| COMP. | −8 | — | x |
| EX. 6 | | | |
| COMP. | −9 | −20 | x |
| EX. 7 | | | |

Evaluation Method
<Degree of Warpage>

An ink-jet recording sheet was placed on a desk so as to become concave to determine the degrees (unit: mm) of rising at 4 corners of the ink-jet recording sheet. The maximum value was regarded as the degree of warpage. In order to represent the direction of the warpage, “+” or “−” was given in accordance with the following standard.

(Ink-Jet Recording Sheet 1)

“+”: Concave when the sheet was placed with the printing surface upward; and
“−”: Convex when the sheet was placed with the printing surface upward.
   (Ink-Jet Recording Sheet 2)
“+”: Concave when the sheet was placed with the first printing surface upward; and
“−”: Convex when the sheet was placed with the first printing surface upward.
   <Rubbing>
∘: No rubbing against the recording head occurred;
x: Rubbing against the recording head occurred.

As described above, the warpage of recording sheets can be corrected according to the present invention.

This application claims priorities from Japanese Patent Application Nos. 2004-171238 filed on Jun. 9, 2004, and 2004-171240 filed on Jun. 9, 2004, which are hereby incorporated by reference herein.

1. A tool comprising a pair of holders capable of detachably holding each of both end portions of a recording sheet and a coupling portion for coupling the pair of holders to each other,
wherein the recording sheet forms a curved surface while the recording sheet is held by the pair of holders, and the recording sheet is held by the pair of holders utilizing a restoring force of the recording sheet with the curved surface formed.

2. The tool according to claim 1, which comprises a planar member and a pair of projecting pieces provided on the side of a surface for holding the recording sheet in the planar member, wherein the pair of holders are formed from the pair of projecting pieces.

3. The tool according to claim 2, wherein the projecting pieces can be formed by three-dimensionally bending a part of the planar member toward the holding surface side of the planar member.

4. The tool according to claim 3, which can be reversibly changed between a three-dimensional state and a flat state.

5. The tool according to claim 1, wherein the ends of the recording sheet come into point or line contact with the pair of holders while the recording sheet is held by the holders.

6. The tool according to claim 1, wherein the recording sheet is an ink-jet recording sheet.

7. The tool according to claim 6, wherein the ink-jet recording sheet is double-side printable.

8. The tool according to claim 1, wherein a plurality of the tools are formed in a master sheet in a state that the tools can be respectively cut off.

9. The tool according to claim 1, wherein the recording sheet has been already subjected to printing.

10. A method for drying a recording sheet, which comprises installing a recording sheet subjected to printing in the pair of holders, with which the tool according to any one of claims 1 to 8 is equipped, to dry the recording sheet.

11. A unit comprising the tool according to claim 1 and a recording sheet.

12. The unit according to claim 11, wherein the length of the tool is not longer than the length of a long side of the ink-jet recording sheet.

13. A method for correcting warpage of a recording sheet, which comprises holding the recording sheet by a tool by which each of both end portions of the recording sheet before recording can be detachably held, the recording sheet forms a curved surface while the recording sheet is held, and the recording sheet can be held while utilizing a restoring force of the recording sheet with the curved surface formed.

14. A method for correcting warpage of a recording sheet, which comprises holding the recording sheet by a tool by which each of both end portions of the recording sheet subjected to recording can be detachably held, the recording sheet forms a curved surface while the recording sheet is held, and the recording sheet can be held while utilizing a restoring force of the recording sheet with the curved surface formed.

15. The method according to claim 13, wherein the recording sheet is an ink-jet recording sheet.

16. The method according to claim 14, wherein the recording sheet is an ink-jet recording sheet subjected to recording in accordance with an ink-jet recording method.

17. The method according to claim 15, wherein the ink-jet recording sheet is corrected before the ink-jet recording sheet is subjected to printing in such a manner that a printing surface of the ink-jet recording sheet becomes flat or convex.

18. The method according to any one of claims 15 to 17, wherein the recording sheet is double-side printable.

19. The method according to claim 18, wherein after printing is conducted on one surface of the ink-jet recording sheet and before printing is conducted on the other surface of the ink-jet recording sheet, the ink-jet recording sheet is corrected in such a manner that the printed surface of the ink-jet recording sheet becomes flat or concave.
